(19) United States
(12) Patent Application Publication
(10) Pub. No.: US 2008/0059182 A1
(43) Pub. Date: Mar. 6, 2008

(54) Intelligent system of speech recognizing physicians' data

(76) Inventors: Anuthep Benja-Athon, New York, NY (US); Sirikit Benja-Athon, Port Washington, NY (US)

Correspondence Address: AUNTHEP BENJA-ATHON, M.D., 210 E 36TH ST., GR. FLOOR, NEW YORK, NY, 10016, US

(21) Appl. No.: 11/973,866

(22) Filed: Oct. 11, 2007

Related U.S. Application Data
(63) Continuation-in-part of application No. 11/543,895, filed on Oct. 6, 2006.
(63) Continuation-in-part of application No. 11/510,820, filed on Aug. 28, 2006.
Application No. 11/543,895 is a continuation-in-part of application No. 11/477,121, filed on Jun. 29, 2006.
Application No. 11/477,121 is a continuation-in-part of application No. 11/255,229, filed on Oct. 21, 2005.
Application No. 11/255,229 is a continuation-in-part of application No. 11/114,763, filed on Apr. 27, 2005.
Application No. 11/114,763 is a continuation-in-part of application No. 11/074,236, filed on Mar. 7, 2005.
Application No. 11/114,763 is a continuation-in-part of application No. 11/059,088, filed on Feb. 16, 2005.

(51) Int. Cl. G10L 15/00

(52) U.S. Cl. 704/251; 704/E15.001

(57) ABSTRACT

An intelligent system of orders and placements of words, terms and phrases in the vocabularies of grammar files of a speech recognition program to approximate or match physicians' logics, thoughts and to compensate for the variations in and diversities of health and health-care data and information on patients to effect the accuracy and optimal outcomes of the speech recognition.

This application is a continuation-in-part of Ser. No. 11/543,895 entitled the Vital Elements of Speech Recognition filed Oct. 6, 2006 and a continuation-in-part of Ser. No. 11/510,820 entitled Words for Managing Health and Health-care Information filed Aug. 28, 2006 and is a continuation-in-part of Ser. No. 11/477,121 entitled the Medical Vocabulary Templates in Speech Recognition filed Jun. 29, 2006 which is a continuation-in-part of Ser. No. 11/255,229 entitled the Best Method of Computerized Transcriptions filed Oct. 21, 2005 which is continuation-in-part of Ser. No. 11/114,763 entitled System of Influencing Health-Care Utilizations filed Apr. 27, 2005 which is a continuation-in-part of Ser. No. 11/074,236 entitled System of Health-Care Resources file Mar. 7, 2005 and Ser. No. 11/059,088 entitled Consumers Buyers-Physicians Health-Care filed Feb. 16, 2005 which are pending.

### FIELD OF THE INVENTION

Orders and placements of words and phrases in the vocabularies of speech recognition grammars.

### BACKGROUND OF THE INVENTION

Applications Ser. No. 11/543,895 entitled the Vital Elements of Speech Recognition, Ser. No. 11/477,121 entitled the Medical Vocabulary Templates in Speech Recognition, Ser. No. 11/510,820 entitled Words for Managing Health and Health-care Information and Ser. No. 11/255,229 entitled the Best Method of Computerized Transcriptions are the most innovative technology on speech recognition of computerized conversions of digital audio, voice or speech data on health and health-care data on millions of patients produced by thousands of physicians to digital text data. Said and present invention inventions provide the only system of optimally speech recognizing health and health-care data and information on patients generated by physicians to optimally convert said voice data and information into text data and information. Thus, said and present inventions provide physicians, computers and servers and their speech recognition engines with the best and most innovative means for speech recognition of said data.

The present invention further provides an even more intelligent system of speech recognition of health and health care data and information produce by physicians.

Specifically, as a further improvement, the present invention provides an intelligent means, methods and processes for compensating for and addressing the vast variations, diversities and differences in said data and information generated by physicians and further improves and enhances the goals and objectives of said pending applications.

Therefore, the present invention provides an even more versatile and intelligent system for accurately and rapidly converting massive data on health and health-care data and information on hundred of millions of patients generate by millions of brains of physicians into digital data. Said pending and present applications, therefore, will certainly channel billions of health-care dollars, tangible and intangible benefits per day to positively affect and improve the lives of millions of people in America and the world. Therefore, the current health-care crisis is resolved by said patent applications.

### SUMMARY OF THE INVENTION

Since the filings of said patent applications and a result of the present patent applicants' continuing research and further refinements on the application of the speech recognition technology in health-care, the present invention further improves and optimizes the accuracy and outcomes of the speech recognition of digital voice data and information on patients generated by physicians.

The present invention is an intelligent system of vocabularies in the grammar files means for speech recognition of health and health-care data and information on patients generate by physicians comprising orders and placements of words, phrases, terms and the synonyms and equivalences of said words, phrases and terms, orders and placements of related words, phrases, terms and synonyms and equivalences of said words, phrases and terms, and orders and placements of related groups of words, phrases, terms or any combination thereof and synonyms and equivalences of said groups to approximate or match the physicians' logics, thoughts or concepts on and productions of said health and health-care data and information and to compensate and account for the variations in and diversities of said data and information and to effect the accuracy and optimize the outcomes of the speech recognition of said data and information.

### DESCRIPTION OF THE PREFERRED EMBODIMENTS

In order to facilitate the understanding of the description of the preferred embodiments of the present invention, it is necessary to briefly reintroduce—but, preferably, refer to the preferred embodiments of said pending patent applications—Vital Elements of Speech Recognition, Medical Vocabulary Templates in Speech Recognition, and Words for managing health and health-care information.

As a continuation-in-part of said pending patent applications, the present invention uses the system of templates of vocabularies comprising medical and surgical words, terms, phrases, acronyms, synonyms, codes used, use and to be used in medicine and surgery by physicians in about 80 medical and surgical specialties or practices in the speech recognition of digital voice data and information on patients produce by physicians.

However, the present invention implements more innovations and intelligence in the vocabularies of said speech grammar files and grammar rules and speech recognition. What is more innovative or more intelligent of the present invention is that the present invention provides an intelligent system and method of medical-logically and medical-logistically applying medical and surgical words, phrases, terms and synonyms and related words, phrases, terms, synonyms and equivalences and related groups of words, phrases, terms or any combination thereof and synonyms and equivalences of said groups—henceforth contents—in the vocabularies of the grammars and also in the programs in the speech recognition engine and speech recognition process, first, to approximate, match, reflect, mimic, copy, simulate, replicate and/or duplicate the physicians' logics, concepts, thoughts, thought processes, trends of thoughts, algorithms on medicine, surgery, health and health-care data and information on patients and the contents of said data and information comprising words, phrases, terms on patients generated by said physicians to achieve the objectives and goals of the present invention.

Second, further to supra, to address, compensate and account for the variations in and diversities of said data and information to further effect the accuracy and optimize the outcomes of the speech recognition of said data and information by speech recognition engine to further the objectives and goals of the present invention.

Therefore, the illustrations infra briefly and schematically illustrate the present invention which, in fact, like said pending patent applications comprise multiple large and extremely complex albeit logical vocabularies and grammar files on health, health-care, medicine and surgery—described earlier in said pending patent applications—solely generated by the present patent applicants in the Grammar Editor window of the Microsoft Corporation speech recognition programs.

Illustration 1 schematically represents an order of words, phrases, terms and the synonyms and equivalences and related words, phrases, terms and the synonyms and equivalences in a speech recognition vocabulary of the present invention being displayed on the Grammar Editor window of Microsoft Speech Recognition program.

| | | | | |
|---|---|---|---|---|
| Consultation | Chief complaint | Headache | Diagnosis | Flu |
| Visit | Chief complaints | Migraine | Diagnoses | Migraine |
| Follow-up | Complaint | Fever | Assessment | Meningitis |
| Reevaluation | Finding | Mass | Finding | Viral |
| | | | | infection |
| Examination | Complaints | Tics Spasm | Findings | Cold |
| Evaluation | Manifestation | Diarrhea | | Acne |

Illustration 2 schematically represents a extremely small order of related words, phrases, terms and synonyms and equivalences of said words, phrases and terms and related groups of words, phrases, terms or any combination thereof and synonyms and equivalences of said groups in a speech recognition vocabulary of the present invention.

| | | | | |
|---|---|---|---|---|
| Consultation | Chief complaint | Headache | Diagnosis | Flu |
| Visit | Chief complaints | Migraine | Diagnoses | Cold |
| Follow-up | Complaint | Head pain | Assessment | Influenza |
| Reevaluation | Finding | Mass | Finding | Viral infection |
| Examination | Complaints | Tics Spasm | Findings | cord hemisection |
| Evaluation | Manifestation | Fever | | hemisection of cord |
| | | Weakness | | Brown-Séquard's |
| | | | | syndrome |
| | | Paralysis | | |
| | | Sensory loss | | |
| | | Falling | | |
| | | loss of pain | | |
| | | loss of temperature | | |
| | | ipsilateral pyramidal | | |
| | | deficit | | |
| | | contralateral loss of | | |
| | | pain temperature | | |

Illustration 3 schematically shows the present invention as an intelligent system able to use and recognize synonyms and that related words and/or phrases or related groups of words and/or phrases produced or spoken differently have the same meaning and implication thus be appropriately speech recognized and processed as one of the preferred embodiments of the present invention. For example, the word “sciatica” has the same meaning as a phrase or “radiation pain”, “cervical pain” has the same meaning as “neck pain” and “cervicalgia” and the like:

| | | | |
|---|---|---|---|
| Chief complaint | Leg pain | Diagnosis | Lumbar radiculopathy |
| Chief complaints | Sciatica | Diagnoses | Lumbar radiculitis |
| Complaint | Radiation | Assessment | Impingement of L5 nerve |
| | pain | | root |
| Finding | Paresis | Finding | Loss of reflex |
| Complaints | Paresthesias | Findings | Neurogenic claudication |
| Manifestation | Cold leg | | Mononeuropathy |
| | Neck pain | | Cervical pain |
| | | | Cervicalgia |

Corollary, there is an abundance of synonyms in medicine, health and health-care such as, but not limited to, neck pain, cervical pain, cervicalgia, cerviobrachial pain syndrome, carpal tunnel syndrome and carpal canal syndrome which is addressed by the preferred embodiments of the present invention

Conversely, according to the preferred embodiments of the present invention, the speech recognition process and engine are able to distinguish similar words, terms or phrases having different meanings, such as, but not limited to, cervical pain or neck pain from cervical pain in the pelvis.

Illustration 4 schematically represents another order of related words, phrases, terms and synonyms and equivalences of said words, phrases and terms and related groups of words, phrases, terms or any combination thereof and synonyms and equivalences of said groups of any and all vocabularies of the present invention wherein any and all words, phrases, terms, synonyms and equivalences are appropriately and repeatedly used by the present invention in speech recognition. For example, any physician may present to the present invention a voice data on his or her patient as follows:
. . . Complaint Arm paralysis Leg paralysis Diagnosis Cord hemisection Brown-Séquard's syndrome . . .

Said voice data is speech recognized by the speech recognition engine using the following representative vocabulary:

| | | | |
|---|---|---|---|
| Chief complaint | Leg weakness | Diagnosis | Brown-Séquard's syndrome |
| Chief complaints | Leg | Diagnoses | Hemisection of the cord |
| Complaint | Arm | Assessment | Cord hemisection |
| Finding | paralysis | Finding | Transverse cord hemisection |
| Complaints | Sensory loss | Findings | Dejerine-Roussy syndrome |
| Manifestation | Falling | | Thalamic lesions |
| | Loss of temperature | | Creutzfeldt-Jakob disease |
| | Loss of pain | | Jakob-Creutzfeldt disease |
| | Ipsilateral pyramidal deficit | | |
| | Contralateral loss of pain temperature | | |
| | Loss all sensations on contralateral side of body | | |
| | Impairment all sensations on contralateral side of body | | |
| | Spontaneous pain on affected side | | |
| | Burning tearing knifelike stabbing pain | | |
| | Dementia | | |
| | Behavioral abnormalities | | |
| | Focal cortical disorder | | |
| | Myoclonus | | |
| | Extrapyramidal signs | | |
| | Cerebellar disorder | | |
| | Pyramidal signs | | |
| | Lower motor neuron signs | | |
| | Visual disturbances | | |

According to said preferred embodiments, first, the present invention causes the programmed speech recognition engine to repeatedly use the word “paralysis” twice and align other words, i.e. “Arm” and “Leg” to said use in the speech recognition of said physician's information. Thus, the desire logical and sensible text outcome of said speech recognition is as follows:
. . . Complaint Arm paralysis Leg paralysis Diagnosis Cord hemisection Brown-Séquard's syndrome . . .

Further to same, second, the present invention causes the programmed speech recognition engine to use groups of related words, terms, phrases and synonyms and related groups of words, terms, phrases, synonyms to speech recognize physicians' health and health-care data and information to achieve the goals and objectives of the present invention. For example, a first group of related words “Chief complaint” “Leg” “Arm” “paresis” and second group of related words “Diagnosis” “Brown-Séquard's syndrome” “Cord hemisection” in said sample vocabulary are used by the speech recognition engine to speech recognize any and all logical and medical health and health-care information structures of a physician's and all physicians' data and information being speech recognized.

A second example—of infinite examples—is a first group of related words “Chief complaint” “Loss all sensations on contralateral side of body” “Impairment all sensations on contralateral side of body” “Spontaneous pain on affected side” “Burning tearing knifelike stabbing pain” and second group of related words “Diagnosis” “Dejerine-Roussy syndrome” in said sample vocabulary are used by the speech recognition engine to speech recognition any logical and medical, health and health-care information structures of a physician's data being speech recognized.

Furthermore, the speech recognition outcomes based on the preferred embodiments of the present invention will be the same for said physician's and any and all physicians' health and health-care data and information on patients in any and all logical variations, permutations and possibilities present to the present invention such as, but not limited to, the following:
. . . Complaint Arm paralysis Leg paralysis Diagnosis Cord hemisection Brown-Séquard's syndrome . . .
   or
. . . Complaint Leg paralysis Arm paralysis Diagnosis Cord hemisection Brown-Séquard's syndrome . . .
   or
. . . Complaint Arm paralysis Leg paralysis Diagnosis Brown-Séquard's syndrome Cord hemisection . . .
   etc.

The present invention provides the speech recognition process and engine with an intelligent system of and means for speech recognizing health and health-care data and information on patients generated by physicians base on the orders, placements or positions of said words, phrases, terms and the synonyms and equivalences of said words, phrases and terms, related words, phrases, terms and synonyms and equivalences of said words, phrases and terms, and orders of related groups of words, phrases, terms or any combination thereof and synonyms and equivalences of said groups in said vocabularies.

Illustration 5, further to supra, schematically represents the present invention's ability to correct words, terms, phrases or groups of words, terms and phrases produced or spoken out of contexts but are speech recognized and processed to fit within the contexts. For example, a physician may have produce a voice file infra—with an error or out-of-context contents—such as, but not limited to the following example:
. . . Chief complaint Hand pain Toe paresthesias, tingling, pins and needles . . .

which is speech recognized and corrected using the following part of a representative part of a vocabulary:

| | | | |
|---|---|---|---|
| Chief complaint | Hand pain | Diagnosis | Entrapment neuropathy |
| Chief complaints | Digit paresthesias | Diagnoses | Compressive neuropathy |
| Complaint | Pins and needles | Assessment | Carpal tunnel syndrome |
| Finding | Tingling | Finding | Carnal canal syndrome |
| Complaints | Thenar atrophy | Findings | |
| Manifestation | Raynaud's phenomenon | | |
| | Cool skin | | |

to produce the following correct outcome as follows:
. . . Chief complaint Hand pain Digit paresthesias, tingling, pins and needles . . .

It is to be understood that any or all said preferred embodiments of the present invention are to be implemented and used in the speech recognition programs and software of corporations such as, but not limited to, Microsoft Corporation, wherein the speech recognition engines, grammar files, grammar rules and vocabularies and related are programmed to achieve the objectives and goals of the present invention.

Adaptations, editions and improvements of the present invention can and will be constantly done and achieved to fulfill the needs, applications or requirements of a physician, a group of physicians, groups of physicians and organizations of physicians in all medical and surgical specialties to achieve the goals and objectives of the present invention.

Although the present invention is applicable to the Microsoft Corporation speech recognition programs, it will be appreciated by those skilled in the art that the present invention is applicable to the derivatives of said programs and may be applicable to the speech recognition programs and their derivatives of other companies and corporations within the spirit of the invention and the scope of the claims.

Although various preferred embodiments of the present invention have been described, it will be appreciated by those skilled in the art that adaptations, editions, variations and improvements may be made without departing from the spirit of the invention and the scope of the claims.

1. An intelligent system of vocabularies in the grammar files means for speech recognition of health and health-care data and information on patients generate by physicians comprising orders and placements of words, phrases, terms and the synonyms and equivalences of said words, phrases and terms, orders and placements of related words, phrases, terms and synonyms and equivalences of said words, phrases and terms, and orders and placements of related groups of words, phrases, terms or any combination thereof and synonyms and equivalences of said groups to approximate or match the physicians' logics, thoughts or concepts on and productions of said health and health-care data and information and to compensate and account for the variations in and diversities of said data and information and to effect the accuracy and optimize the outcomes of the speech recognition of said data and information comprises:
a process of recognizing related words, terms and phrases approximating physicians' logics on said data and information;
a process of recognizing related words, terms and phrases matching physicians' logics on said data and information;
a process of recognizing related words, terms and phrases approximating physicians' words, terms and phrases in said data and information;
a process of recognizing related words, terms and phrases matching physicians' words, terms and phrases in said data and information;
a process of recognizing related groups of words, terms and phrases approximating physicians' logics on said data and information;
a process of recognizing related groups of words, terms and phrases matching physicians' logics on said data and information;
a process of recognizing related groups of words, terms and phrases approximating physicians' words, terms and phrases in said data and information;
a process of recognizing related groups of words, terms and phrases matching physicians' words, terms and phrases in said data and information;
a process of relating words, terms and phrases;
a process of relating related words, terms and phrases;
a process of relating related groups of words, terms and phrases;
a process of ordering related words, terms and phrases approximating physicians' logics on said data and information;
a process of ordering related words, terms and phrases matching physicians' logics on said data and information;
a process of ordering related words, terms and phrases to approximate physicians' orders of words, terms and phrases in said data and information;
a process of ordering related words, terms and phrases to match physicians' orders of words, terms and phrases in said data and information;
a process of ordering related groups of words, terms and phrases approximating physicians' logics on said data and information;
a process of ordering related groups of words, terms and phrases matching physicians' logics on said data and information;
a process of ordering related groups of words, terms and phrases to approximate physicians' orders of words, terms and phrases in said data and information;
a process of ordering related groups of words, terms and phrases to match physicians' orders of words, terms and phrases in said data and information;
a process of ordering related words, terms and phrases and related groups of words, terms and phrases in the vocabularies of said grammars to compensate for variations in and diversities of said data and information; and
a process of reusing words, terms and phrases in the vocabularies many times in said speech recognition of said physicians' data and information.

2. A method of compensating for variations in and diversities of health and health-care data and information on patients generated by physicians wherein words, phrases, terms and the synonyms and equivalences of said words, phrases and terms, related words, phrases, terms and synonyms and equivalences of said words, phrases and terms, and related groups of words, phrases, terms or any combination thereof and synonyms and equivalences of said groups in vocabularies in the grammar files means for speech recognition of said data and information are ordered and placed to approximate or match said physicians' logics, thoughts or concepts on and productions of said health and health-care data and information comprising words, phrases and terms and to compensate for variations in and diversities of said data and information to effect the accuracy and optimize the outcomes of the speech recognition of said data and information comprises:
a process of recognizing related words, terms and phrases approximating physicians' logics on said data and information;
a process of recognizing related words, terms and phrases matching physicians' logics on said data and information;
a process of recognizing related words, terms and phrases approximating physicians' words, terms and phrases in said data and information;
a process of recognizing related words, terms and phrases matching physicians' words, terms and phrases in said data and information;
a process of recognizing related groups of words, terms and phrases approximating physicians' logics on said data and information;
a process of recognizing related groups of words, terms and phrases matching physicians' logics on said data and information;
a process of recognizing related groups of words, terms and phrases approximating physicians' words, terms and phrases in said data and information;
a process of recognizing related groups of words, terms and phrases matching physicians' words, terms and phrases in said data and information;
a process of relating words, terms and phrases;
a process of relating related words, terms and phrases;
a process of relating related groups of words, terms and phrases;
a process of ordering related words, terms and phrases approximating physicians' logics on said data and information;
a process of ordering related words, terms and phrases matching physicians' logics on said data and information;
a process of ordering related words, terms and phrases to approximate physicians' orders of words, terms and phrases in said data and information;
a process of ordering related words, terms and phrases to match physicians' orders of words, terms and phrases in said data and information;
a process of ordering related groups of words, terms and phrases approximating physicians' logics on said data and information;
a process of ordering related groups of words, terms and phrases matching physicians' logics on said data and information;
a process of ordering related groups of words, terms and phrases to approximate physicians' orders of words, terms and phrases in said data and information;
a process of ordering related groups of words, terms and phrases to match physicians' orders of words, terms and phrases in said data and information;
a process of ordering related words, terms and phrases and related groups of words, terms and phrases in the vocabularies of said grammars to compensate for variations in and diversities of said data and information; and
a process of reusing words, terms and phrases in the vocabularies many times in said speech recognition of said physicians' data and information.

3. A method of ordering and placing words, phrases, terms and synonyms and related words, phrases, terms, synonyms and equivalences and related groups of words, phrases, terms or any combination thereof and synonyms and equivalences of said groups in the grammar files means for speech recognition of physicians' generated health and health-care data and information on patients to approximate or match said physicians' logics, thoughts or concepts on and productions of said data and information comprising words, phrases, terms and to compensate for variations in and diversities of said data and information and to effect the accuracy and optimize the outcomes of the speech recognition of said data and information comprises:
a process of recognizing related words, terms and phrases approximating physicians' logics on said data and information;
a process of recognizing related words, terms and phrases matching physicians' logics on said data and information;
a process of recognizing related words, terms and phrases approximating physicians' words, terms and phrases in said data and information;
a process of recognizing related words, terms and phrases matching physicians' words, terms and phrases in said data and information;
a process of recognizing related groups of words, terms and phrases approximating physicians' logics on said data and information;
a process of recognizing related groups of words, terms and phrases matching physicians' logics on said data and information;
a process of recognizing related groups of words, terms and phrases approximating physicians' words, terms and phrases in said data and information;
a process of recognizing related groups of words, terms and phrases matching physicians' words, terms and phrases in said data and information;
a process of relating words, terms and phrases;
a process of relating related words, terms and phrases;
a process of relating related groups of words, terms and phrases;
a process of ordering related words, terms and phrases approximating physicians' logics on said data and information;
a process of ordering related words, terms and phrases matching physicians' logics on said data and information;
a process of ordering related words, terms and phrases to approximate physicians' orders of words, terms and phrases in said data and information;
a process of ordering related words, terms and phrases to match physicians' orders of words, terms and phrases in said data and information;
a process of ordering related groups of words, terms and phrases approximating physicians' logics on said data and information;
a process of ordering related groups of words, terms and phrases matching physicians' logics on said data and information;
a process of ordering related groups of words, terms and phrases to approximate physicians' orders of words, terms and phrases in said data and information;
a process of ordering related groups of words, terms and phrases to match physicians' orders of words, terms and phrases in said data and information;
a process of ordering related words, terms and phrases and related groups of words, terms and phrases in the vocabularies of said grammars to compensate for variations in and diversities of said data and information; and
a process of reusing words, terms and phrases in the vocabularies many times in said speech recognition of said physicians' data and information.
